(19) United States
(12) Patent Application Publication
(10) Pub. No.: US 2023/0316098 A1
(43) Pub. Date: Oct. 5, 2023

(54) MACHINE LEARNING TECHNIQUES FOR EXTRACTING INTERPRETABILITY DATA AND ENTITY-VALUE PAIRS

(71) Applicant: Optum, Inc., Minnetonka, MN (US)

(72) Inventors: Rajesh Sabapathy, Gurgaon (IN); Gourav Awasthi, Gurugram (IN); Chirag Mittal, Gurgaon (IN); Ankur Gulati, Faridabad (IN)

(21) Appl. No.: 17/658,070

(22) Filed: Apr. 5, 2022

(51) Int. Cl. G06N 5/02; G06F 16/28

(52) U.S. Cl. CPC G06N 5/022; G06F 16/285

(57) ABSTRACT

Various embodiments provide automatic extraction of interpretable and entity-specific data from unstructured/semi-structured data. In some embodiments, a method to extract label-value pairs from an input data record is provided. The method includes identifying label data tokens and value data tokens within the input data record and generating a spatial coordinate set for each thereof within a spatial coordinate scheme associated with the input data record. For example, the spatial coordinate sets may be generated with respect to a rendered format of the input data record. The method further includes, for each label data token, generating coordinate vectors positioned in relation to the value data tokens and selecting a value data token for pairing with the label data token based at least in part on the coordinate vectors and using a vector classification machine learning model that is generated based at least in part on automatic annotation of historical data records.

### BACKGROUND

Various embodiments of the present invention introduce techniques for generating structured data based at least in part on unstructured/semi-structured data and make important technical contributions to reducing storage requirements for storing unstructured/semi-structured data as well as to enabling performance of predictive inferences on unstructured/semi-structured data.

### BRIEF SUMMARY

Various embodiments of the present disclosure provide methods, apparatus, systems, computing devices, computing entities, and/or the like for automatically extracting entity-specific data from unstructured and semi-structured data objects and data records. In various embodiments, an entity (e.g., a concept, a property, a characteristic, and/or the like) that is quantified or qualified by a numerical data value or a categorical data value, respectively, in an unstructured record is identified and associated with the data value to thereby provide interpretable meaning to the data value. The entity may be identified according to a data label also present in the unstructured record. In particular, in example embodiments described herein, data values and data labels within an unstructured record are linked together to form label-value pairs based at least in part on their relative spatial positioning and orientation with respect to a rendered format of the unstructured record. For instance, a data value and a data label that identifies the entity described (e.g., quantified) by the data value may be positioned and oriented together in a recognizable and detectable manner in a displayed, printed, and/or the like format of the unstructured record, in accordance with various embodiments described herein. Various embodiments provide technical solutions for the automatic extraction of label-value pairs (also referred to or understood as entity-value pairs) from unstructured or semi-structured data based at least in part on relative spatial positioning and orientation of the data labels and the data values.

In accordance with one aspect, a computer-implemented method is provided. The computer-implemented method may include identifying a group of entity data tokens including a plurality of label data tokens and a plurality of value data tokens within an input data record. The method may further include, for each entity data token, generating a spatial coordinate set within a spatial coordinate scheme associated with the input data record. The method may further include, for each label data token of the group of entity data tokens: generating a plurality of coordinate vectors positioned in relation to the plurality of value data tokens based at least in part on the spatial coordinate set for each of the plurality of value data tokens, and selecting a selected value data token for the label data token based at least in part on the plurality of coordinate vectors using a vector classification machine learning model. The vector classification machine learning model is generated based at least in part on automatic annotation of a historical dataset of data records using one or more label-value pair regular expressions. The method may further include performing one or more post-extraction actions based at least in part on each selected value data token.

In accordance with another aspect, a computer program product is provided. The computer program product includes at least one computer-readable storage medium having computer-readable program code portions stored therein, and the computer-readable program code portions may include executable portions configured to cause at least one processor to identify a group of entity data tokens including a plurality of label data tokens and a plurality of value data tokens within an input data record. The computer-readable program code portions may further include executable portions configured to cause at least one processor to, for each entity data token, generate a spatial coordinate set within a spatial coordinate scheme associated with the input data record. The computer-readable program code portions may further include executable portions configured to cause at least one processor to, for each label data token of the group of entity data tokens: generate a plurality of coordinate vectors positioned in relation to the plurality of value data tokens based at least in part on the spatial coordinate set for each of the plurality of value data tokens, and select a selected value data token for the label data token based at least in part on the plurality of coordinate vectors using a vector classification machine learning model. The vector classification machine learning model is generated based at least in part on automatic annotation of a historical dataset of data records using one or more label-value pair regular expressions. The computer-readable program code portions may further include executable portions configured to cause at least one processor to perform one or more post-extraction actions based at least in part on each selected value data token.

In accordance with yet another aspect, an apparatus including a processor and at least one memory including computer program code is provided. The at least one memory and the computer program code may be configured to, with the processor, cause the apparatus to identify a group of entity data tokens including a plurality of label data tokens and a plurality of value data tokens within an input data record. The at least one memory and the computer program code may be further configured to, with the processor, cause the apparatus to, for each entity data token, generate a spatial coordinate set within a spatial coordinate scheme associated with the input data record. The at least one memory and the computer program code may be further configured to, with the processor, cause the apparatus to, for each label data token of the group of entity data tokens: generate a plurality of coordinate vectors positioned in relation to the plurality of value data tokens based at least in part on the spatial coordinate set for each of the plurality of value data tokens, and select a selected value data token for the label data token based at least in part on the plurality of coordinate vectors using a vector classification machine learning model. The vector classification machine learning model is generated based at least in part on automatic annotation of a historical dataset of data records using one or more label-value pair regular expressions. The at least one memory and the computer program code may be further configured to, with the processor, cause the apparatus to perform one or more post-extraction actions based at least in part on each selected value data token.

### BRIEF DESCRIPTION OF THE DRAWINGS

Having thus described the invention in general terms, reference will now be made to the accompanying drawings, which are not necessarily drawn to scale.

FIG. 1 provides an exemplary overview of an architecture that may be used to practice embodiments of the present disclosure.

FIG. 2 provides a diagram of an example system computing entity, in accordance with some embodiments discussed herein.

FIG. 3 provides a diagram of an example client computing entity, in accordance with some embodiments discussed herein.

FIGS. 4A and 4B demonstrate example technical challenges associated with automatic extraction of entity-specific value data tokens from data objects and/or data records.

FIG. 5 provides a flowchart diagram of an example process for extracting entity label-value pairs from a data record, in accordance with various embodiments described herein.

FIG. 6 provides a flowchart diagram of an example process for generating a vector classification machine learning model configured for use in extracting entity values from a data record, in accordance with various embodiments described herein.

FIG. 7 provides a diagram illustrating an overview of example operations performed to automatically annotate historical data records in order to generate and/or train a vector classification machine learning model configured for use in extracting entity values from a data record, in accordance with various embodiments described herein.

FIG. 8 illustrates example entity-specific value distributions that may be used to eliminate candidate values when extracting entity values from a data record, in accordance with various embodiments described herein.

FIG. 9 provides a diagram illustrating generation and training of an example vector classification machine learning model, in accordance with various embodiments described herein.

FIG. 10 illustrates an example joint probability distribution that may represent classifications made by a vector classification machine learning model and/or embody a vector classification machine learning model, in accordance with various embodiments of the present disclosure.

FIG. 11 provides an operational example for extracting interpretable and entity-specific data from an unstructured data record, in accordance with various embodiments described herein.

### DETAILED DESCRIPTION

Various embodiments of the present disclosure now will be described more fully hereinafter with reference to the accompanying drawings, in which some, but not all, embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present disclosure are described with reference to providing text-based summarizations of conversations, one of ordinary skill in the art will recognize that the disclosed concepts can be used in other summarization and/or text extraction applications.

### I. Overview and Exemplary Technical Improvements

Various embodiments of the present invention make important technical contributions to improving data storage efficiency. For example, various embodiments of the present invention disclose techniques for generating structured data based at least in part on unstructured/semi-structured data by extracting key-value associations from the unstructured/semi-structured data. Because associated keys and values form only a subset of an unstructured/semi-structured corpus, storing structured data generated based at least in part on underlying unstructured/semi-structured data requires less storage resources than storing the underlying unstructured/semi-structured data. In this way, by disclosing techniques for generating structured data based at least in part on unstructured/semi-structured data, various embodiments of the present invention improve storage efficiency of storing data and reduce the amount of storage resources needed for storing data. In this way, various embodiments of the present invention make important technical contributions to improving data storage efficiency.

Various embodiments of the present disclosure address technical challenges associated with improving applicability, reliability, and operational efficiency for data record interpretation server systems. In their unstructured and semi-structured formats, some data records and documents may be difficult to interpret. Such data records may lack sufficient information (e.g., metadata) to describe the domain, meaning, context, and/or the like that is relevant to each data value. As one example, an unstructured data record such as an image scan of a document may capture various values and text data, and while a human user may visually ascertain what entities are described by each value, the image scan may not explicitly define the entity for each value. Further, some data records may have inconsistent formats such that existing techniques struggle to consistently and reliability determine an entity-specific interpretation for each value.

Thus, for example, existing interpretation systems may struggle to determine whether a data value of 50 appearing within an unstructured data record should be interpreted and processed with respect to a weight entity, a height entity, an age entity, or any other conceivable entity. To account for these deficiencies, existing systems and techniques rely upon manual inputs and manually-performed operations via human operators that inherently have the domain knowledge and understanding necessary to assign an entity to each data value within an unstructured or semi-structured data record such that downstream interpretation and processing actions can be appropriately performed without mis-distributed or mis-assigned respective input values.

Moreover, various embodiments of the present invention make substantial technical improvements to performing operational load balancing for the post-prediction systems that perform operations on structured data that are generated based at least in part on extracted key-value associations extracted from unstructured/semi-structured data objects. For example, in some embodiments, a predictive data analysis computing entity determines D structured data objects for S unstructured/semi-structured data objects. Then, the count of D structured data objects, along with a resource utilization ratio for each structured data object, can be used to predict a predicted number of computing entities needed to perform post-prediction processing operations with respect to the D structured data objects. For example, in some embodiments, the number of computing entities needed to perform post-prediction processing operations (e.g., structured data processing operations) with respect to D structured data objects can be determined based at least in part on the output of the equation: R=ceil(Σₖ^{k=D} urₖ), where R is the predicted number of computing entities needed to perform post-prediction processing operations with respect to the D structured data objects, cell(.) is a ceiling function that returns the closest integer that is greater than or equal to the value provided as the input parameter of the ceiling function, k is an index variable that iterates over the D structured data objects, and urₖ is the estimated resource utilization ratio for a kth structured data objects that may be determined based at least in part on size of the structured data object. In some embodiments, once R is generated, a predictive data analysis computing entity can use R to perform operational load balancing for a server system that is configured to perform post-prediction processing operations with respect to D structured data objects. This may be done by allocating computing entities to the post-prediction processing operations if the number of currently-allocated computing entities is below R, and deallocating currently-allocated computing entities if the number of currently-allocated computing entities is above R.

Various embodiments described herein address these technical challenges through enabling automatic pairing of value data tokens captured within an unstructured data record to label data tokens that identify an entity (e.g., a concept, a property, a characteristic, and/or the like). With this automatic pairing or automatic extraction of label-value pairs, various embodiments extract and generate interpretability and entity-specific data to expand applicability of data record interpretation server systems to unstructured and semi-structured data records. In various embodiments, the extraction of entity-specific data is based at least in part on the spatial positioning and orientation of the value data tokens and label data tokens that identify the entities. In particular, the spatial positioning and orientation of the various data tokens are defined with respect to a spatial coordinate scheme associated with the unstructured data record, such as a scheme bounded by the dimensions and scale of a rendered form of the unstructured data record (e.g., displayed, printed), in order to mimic or replicate the visually ascertaining of label and value relationships by a human operator. Accordingly, a value data token and a label data token that may be spatially positioned and oriented in a particular relative manner when rendered may be paired.

In particular, the spatial positioning and orientation between value data tokens and label data tokens are evaluated in light of historical ground-truth label-value pairs captured within historical unstructured data records. Generally, in various embodiments, generalized regular expression modules are used in semantic text versions of the historical unstructured data records to identify the ground-truth label-value pairs, and the ground-truth label-value pairs are then located within the historical unstructured data records. The spatial positions and orientations of the ground-truth label-value pairs within historical unstructured data records are learned and used to evaluate potential label-value pairings. In various embodiments, a vector classification machine learning model is generated and/or trained to automatically determine whether a value data token and a label data token should be paired according to their spatial positioning and orientation.

Thus, as described herein, various embodiments of the present disclosure address technical challenges associated with improving applicability, consistency, and reliability of data record and document interpretation server systems. Entity-specific data is extracted from unstructured or semi-structured data records through automatic pairing of value data tokens with label data tokens that identify the entities (e.g., concepts, properties, characteristics, and/or the like) described by the value data tokens. Accordingly, applicability of data record interpretation server systems may be expanded to unstructured or semi-structured data objects, generally. Further, various embodiments of the present disclosure enable end-to-end automation of record retrieval and interpretation using vector classification machine learning models generated and/or trained using historical ground-truth pairing data, thereby obviating manual inputs and actions to improve operational efficiency and throughput of record interpretation server systems, in various examples. Various embodiments employ entity-agnostic concepts and mechanisms such that label-value pair extraction can be performed for any entity and any number of entities, resulting in improved scalability.

### II. Exemplary Definitions of Certain Terms

The term “entity data token” may refer to a data entity configured to identify or describe a concept, an entity, a property, a characteristic, and/or the like. An entity data token may specifically be a label data token or a value data token, in various embodiments. In various embodiments, an entity data token comprises one or more text characters (e.g., alphanumerical characters) that define one or more words. In various embodiments, an entity data token may be a vector, a string, an array, a matrix, embeddings, and/or the like.

The term “label data token” may refer to a data entity configured to identify a concept, an entity, a property, a characteristic, and/or the like that is described by a data record and specifically with respect to a data variable. Generally, a label data token comprises text data (e.g., one or more character-level tokens, word-level tokens, sentence-level tokens, and/or the like) that uniquely identifies and labels a particular concept, entity, property, characteristic, and/or the like; thus, a label data token may be entity-specific. In uniquely identifying an entity and/or the like, a label data token may be in the form of a commonly understood name for the entity or an abbreviation of such a name. For instance, example label data tokens that may be specific to the same entity may include body mass index, BMI, B.M.I., and body MI. Other various example label data tokens may include height, weight, age, dimensions, and/or the like, and generally, an entity identified by a label data token may be further described (e.g., quantified) by a data variable. According to various embodiments, a label data token provides domain context to a data variable, such as a numerical value or a categorical value, such that the data variable may be interpreted with respect to the entity (and/or the like) uniquely identified by the label data token. In various embodiments, a label data token may be an array (e.g., of text characters), a vector, a matrix, embeddings, and/or the like.

The term “value data token” may refer to a data entity configured to describe a concept, an entity, a property, a characteristic, and/or the like. Value data tokens may quantify or qualify the concept, the entity, the property, the characteristics, and/or the like via a numerical value or a categorical value, respectively. As one non-limiting illustrative example, a value data token of 170 may describe and quantity an entity identified as weight, for example. As another non-limiting illustrative example, a value data token of blue may describe and qualify an entity identified as color, for example. In various embodiments, a value data token may be a scalar data value, one or more text characters, a vector, a matrix, an array, and/or the like. In a rendered format of a data record (e.g., displayed, physically printed) in which a value data token appears, the value data token may be spatially related or associated with a label data token identifying an entity (and/or the like), such that the value data token can be interpreted by a human user as describing (e.g., quantifying, qualifying) the entity identified by the label data token. However, when the association of a value data token with a specific entity may be unclear in other formats of the data record and/or when automatically processing the data record without a human user. Accordingly, various embodiments are directed to automatically and intelligently extracting entity-specific data from a data record based at least in part on linking a value data token with a corresponding label data token.

The term “label-value pair” may generally refer to a pairing, a linking, an association, and/or the like of a value data token and a label data token. The value data token and the label data token of a label-value pair may be accordingly paired based at least in part on the value data token describing (e.g., quantifying, qualifying) the entity identified by the label data token. As one non-limiting illustrative example, a value data token of 170 may be paired with a label data token of weight, for example, to indicate that 170 is a quantification of weight. In various embodiments, the pairing of a value data token of 170 with a label data token is dependent on its context (e.g., other value data tokens, other label data tokens, spatial orientation and positioning of the value data token and the label data token); otherwise, the value data token of 170 could be alternatively (e.g., and incorrectly) paired with other label data tokens of age or height. In various embodiments, a label-value pair may be a data entity that comprises both a value data token and a label data token determined to be associated together. For example, one or more label-value pairs may be a vector, an array, a matrix, a data structure (e.g., a linked data structure, a tree), a graph), and/or the like.

The term “historical primary data record” may refer to a data entity that includes a plurality of label data tokens and a plurality of value data tokens in an unstructured or a semi-structured format. A historical primary data record may be renderable in a format in which a human user may understand and recognize a context or a contextual layout that conveys pairings between label data tokens and value data tokens; however, a historical primary data record may be unstructured or a semi-structured such that the historical primary data record does not include explicitly data-defined relationships for each value data token to a label data token. For example, a historical primary data record may be an image scan of a medical record in which label data tokens (e.g., weight, height, BMI, and/or other physiological entities) and value data tokens may be captured. In particular, historical primary data records may be annotated and processed to obtain ground-truth data for training and/or configuring one or more models used herein in accordance with various embodiments to extract label-value pairs from an input data record (which may also be unstructured or semi-structured). In various embodiments, a historical primary data record may be a data object, a data structure, an array, a matrix, an image, and/or the like comprising the plurality of label data tokens and the plurality of value data tokens.

The term “historical secondary data record” may refer to a data entity that semantically describes information comprised in a historical primary data record. In various examples, a historical secondary data record corresponds to a historical primary data record. In semantically describing and repeating information conveyed by a historical primary data record, a historical secondary data record may include at least a subset of the label data tokens and the value data tokens present within a historical primary data record in a semantic format. In some examples, a historical secondary data record may be a summarization, a nurse or provider note, and/or the like accompanying a historical primary data record that is a medical record. In various embodiments, a historical secondary data record may be a data object, a dataset or a datafile, a data structure, an array, a matrix, an image, and/or the like. A historical secondary data record may be in a particular (semantic) structure or configuration in which label-value pairings are more evident than in the corresponding historical primary data record. For example, a historical secondary data record may include semantic text such as the weight is 170 lbs., using which a pairing of a value data token of 170 and a label data token of weight can be extracted from a corresponding historical primary data record, in various embodiments.

The term “entity-specific value distribution” may refer to a data entity configured to holistically describe a population of value data tokens that describe one concept, entity, property, characteristic, and/or the like. Thus, an entity-specific value distribution may lend statistical measures for interpreting a concept, entity, property, characteristic, and/or the like. For instance, the entity-specific value distribution for one entity may include a range (e.g., a minimum and a maximum) of values, one or more value-wise binned frequencies, and/or the like. In various embodiments, the entity-specific value distribution may be implemented as a histogram, for example. In various embodiments, the entity-specific value distribution may be configured as a data object, a data structure, a vector, an array, a matrix, a dataset, and/or the like.

The term “spatial coordinate set” may refer to a data entity configured to describe a spatial position of a data component of a data record (e.g., a historical primary data record, an input data record) with respect to a spatial coordinate scheme of the data record. For example, the spatial coordinate scheme may be based at least in part on a rendered format of the data record (e.g., displayed, physically printed). In some examples, the spatial coordinate set may be bounded by the dimensions and size of the rendered format of the data record, such that the spatial coordinate set specifies one or more points within the data record. Each entity data token, such as a label data token or a value data token, may be associated with a spatial coordinate set. In various embodiments, the spatial coordinate set may specify points that define a bounding box surrounding the rendered form of the entity data token. In various embodiments, the spatial coordinate set may include a coordinate point defining a center point of the rendered form of the entity data token. In various embodiments, a spatial coordinate set for an entity data token may be a vector, an array, a matrix, one or more scalar data values, and/or the like.

The term “coordinate vector” may generally refer to a vector spatially spanning between two rendered data components (e.g., rendered entity data tokens) associated with two spatial coordinate sets. Accordingly, some example coordinate vectors may be generated to describe a relative spatial positioning and orientation of two data components or data tokens with respect to a spatial coordinate scheme associated with a data record comprising the two data components or data tokens. In various embodiments, a coordinate vector may be defined according to a radially/polar-based scheme, such as via a radius or distance and an angle. In other example embodiments, a coordinate vector may be defined according to Cartesian coordinates, a regression output and/or regression coefficients, and/or the like. In various embodiments, a coordinate vector may be embodied by a data entity that may be a data object, a data vector, a matrix, an array, one or more scalar values, and/or the like.

The term “vector classification machine learning model” may refer to a data entity configured to predict or determine whether a coordinate vector is representative of a relative spatial positioning and orientation of a value data token and a label data token that identifies a concept, an entity, a property, a characteristic, and/or the like described (e.g., quantified, qualified) by the value data token. Accordingly, based at least in part on a classification output or a prediction output of the vector classification machine learning model for different coordinate vectors that span between a particular label data token and different value data token, a specific value data token can be selected for pairing with the particular label data token (or vice versa—a specific label data token can be selected for pairing with a particular value data token using coordinate vectors that span between the particular value data token and different label data tokens). In various example embodiments, the vector classification machine learning model may be implemented using one or more classifier machine learning models that may be trained via supervised learning to predict whether a coordinate vector is indicative of a label-value pair. For example, the vector classification machine learning model may comprise one or more deep neural network machine learning models (e.g., convolutional neural network, recurrent neural network, graph neural network) configured to generate a prediction output. The supervised learning may entail annotating a plurality of historical primary data records and the coordinate vectors indicative of label-value pairs present therein and interspersing the “ground-truth” coordinate vectors obtained from the historical primary data records with randomly sampled coordinate vectors to generate a training dataset. In various example embodiments, the vector classification machine learning model may be implemented using a joint probability distribution. The joint probability distribution may be with respect to features of coordinate vectors found in the historical primary data records (e.g., angle, distance/radius), and if an input coordinate vector includes features that map to high density areas of the joint probability distribution, then the input coordinate vector can be determined to be indicative of a label-value pair.

### III. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. Exemplary System Architecture

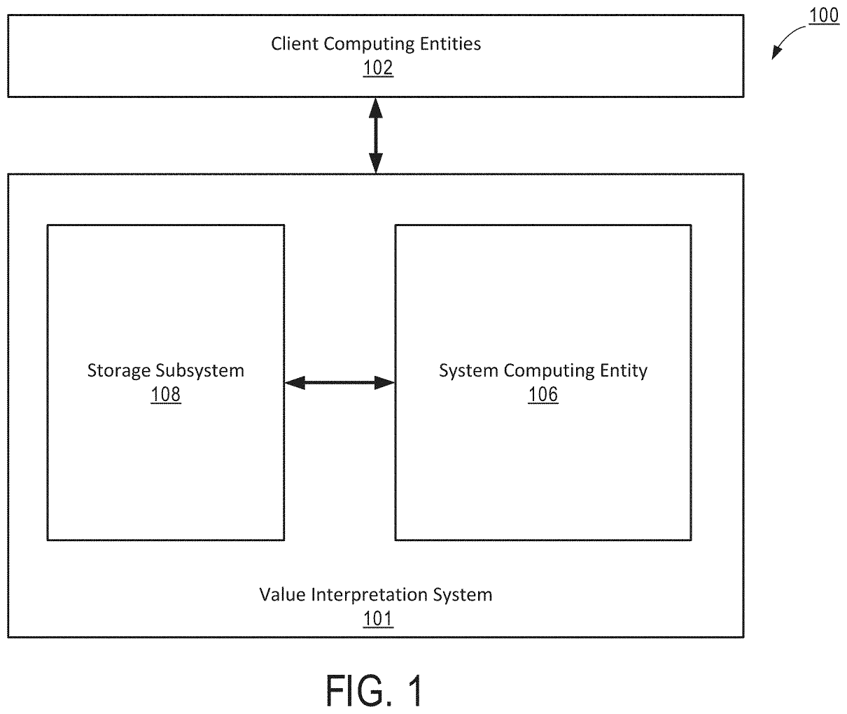

FIG. 1 is a schematic diagram of an example system architecture 100 for automatically extracting entity-specific data from data records in unstructured or semi-structured formats, or in particular, automatically extracting label-value pairs from the data records. As with unstructured or semi-structured formats, a data record may lack data explicitly defining interpretable meaning for a value data token (e.g., what entity, concept, and/or the like is described by the value data token) or may be configured in a manner in which interpretable meaning is difficult to consistent and reliably derived. Thus, the system architecture 100 is configured to pair value data tokens with label data tokens that specifically identify various entities that may be described by the value data tokens. In various embodiments, the system architecture 100 generates coordinate vectors between value data tokens and label data tokens of an input data record and generate label-value pairs based at least in part on evaluating and analyzing the coordinate vectors.

The system architecture 100 includes a value interpretation system 101 configured to generate interpretations for value data tokens in a data record through identifying the concepts, entities, properties, characteristics, and/or the like described by the value data tokens via paired label data tokens. In various embodiments, the value interpretation system 101 generates coordinate vectors between value data tokens and label data tokens of an input data record and generate label-value pairs based at least in part on evaluating and analyzing the coordinate vectors. The value interpretation system 101 may provision, recruit, train, generate, and/or use a vector classification machine learning model for evaluating and analyzing the coordinate vectors to determine whether a coordinate vector is indicative of a label-value pair. In order to generate and/or train the vector classification machine learning model, generally, the value interpretation system 101 may be configured to generate a training dataset for the vector classification machine learning model based at least in part on annotating and identifying “ground-truth” label-value pairs in a historical data records.

As shown in FIG. 1, the value interpretation system 101 may be in communication with one or more client computing entities 102 and may provide value interpretation services for the one or more client computing entities 102. For example, a client computing entity 102 may transmit an unstructured or semi-structured data record to the value interpretation system 101, and the value interpretation system 101 may transmit a plurality of label-value pairs for the data record to the client computing entity 102 in response. In various embodiments, the value interpretation system 101 may receive service requests from one or more client computing entities 102 via one or more application programming interfaces (APIs) through which client computing entities 102 may provide data records and through which the value interpretation system 101 may provide interpretation results or outputs (e.g., a plurality of label-value pairs). In other example embodiments of the system architecture 100, the client computing entities 102 may be responsible for collection/generation of the unstructured or semi-structured data records, and the value interpretation system 101 is not constrained to a requirement to return interpretation results to the client computing entities 102. The value interpretation system 101 may also be configured nonetheless to automatically extract label-value pairs for data records not necessarily obtained originated from client computing entities 102 (e.g., instead via user input, originating from various entities within the value interpretation system, and/or the like).

In some embodiments, the value interpretation system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), one or more cellular communication networks (4G Long Term Evolution, 5G New Radio), and/or the like, as well as any hardware, software and/or firmware required to implement it (such as, e.g., network routers, and/or the like).

The value interpretation system 101 may include a system computing entity 106 and a storage subsystem 108. The system computing entity 106 may be configured to perform various operations described herein to automatically extract label-value pairs from a data record, for example. In various embodiments, the system computing entity 106 may be configured to perform and/or execute operations to generate a vector classification machine learning model (e.g., based at least in part on annotating a plurality of historical data records), to identify or recognize label data tokens and value data tokens within an input data record, to generate coordinate vectors between label data tokens and value data tokens, and to determine whether any coordinate vectors are indicative of label-value pairs using the vector classification machine learning model. In various embodiments, the system computing entity 106 is configured to perform various operations for post-extraction actions, such as transmitting a plurality of label-value pairs, generating a record classification or summarization for the input data record using the plurality of label-value pairs, providing the plurality of label-value pairs to a disease diagnosis model or system, and/or the like.

The storage subsystem 108 may be configured to store certain data for extracting entity-specific data from unstructured or semi-structured data. For instance, in example embodiments, the storage subsystem 108 stores a vector classification machine learning model used to predict whether a given coordinate vector is indicative of a label-value pair. In various embodiments, the vector classification machine learning model comprises one or more classifier machine learning models, and the storage subsystem 108 is accordingly provisioned for the storage of volumes of parameters, biases, hyperparameters, configurations/mappings, and/or the like for the classifier machine learning models. In various embodiments, the storage subsystem 108 is configured to enable a queue of data records (e.g., received originating from the client computing entities 102) in instances in which an influx of data records may exceed the system computing entity's capability for extracting entity-specific data. In various embodiments, the storage subsystem 108 may store one or more historical datasets of data records that may be used to configure, generate, train, and/or the like the vector classification machine learning model. In various embodiments, the storage subsystem 108 may be configured to dynamically manage such historical datasets and add new data records to the historical datasets, for example.

The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

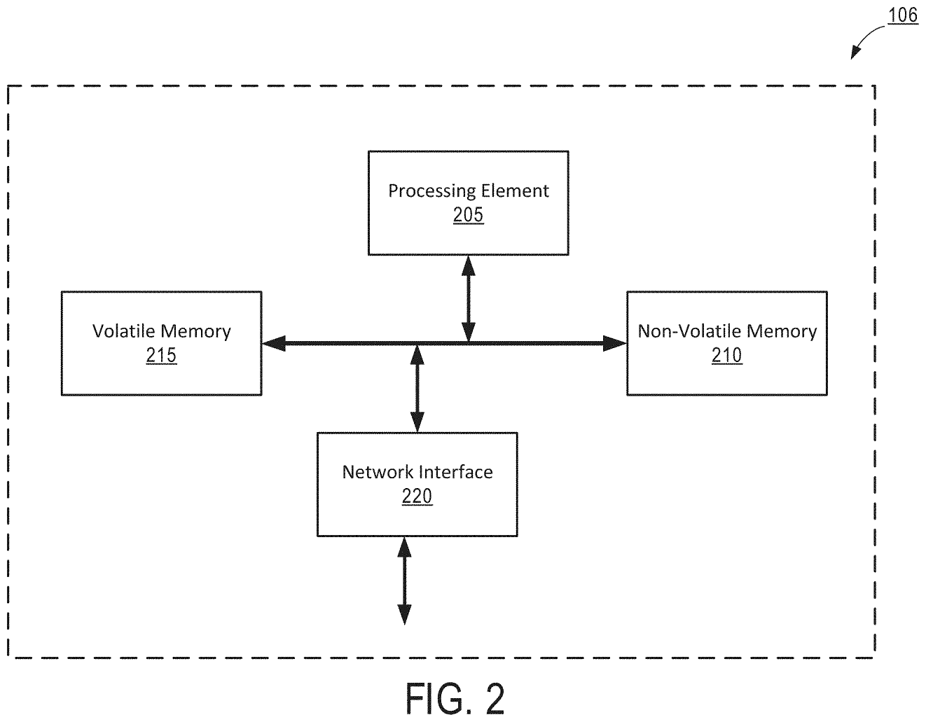

FIG. 2 provides a schematic of a system computing entity 106, according to one embodiment of the present disclosure. As shown in FIG. 2, in one embodiment, the system computing entity 106 may include, or be in communication with, one or more processing elements 205 (also referred to as processors, processing circuitry, and/or similar terms used herein interchangeably) that communicate with other elements within the system computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In one embodiment, the system computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media 210 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity—relationship model, object model, document model, semantic model, graph model, and/or the like.

In one embodiment, the system computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media 215 may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the system computing entity 106 with the assistance of the processing element 205 and operating system.

As indicated, in one embodiment, the system computing entity 106 may also include one or more network interfaces 220 for communicating with various computing entities (e.g., one or more other system computing entities 106, one or more client computing entities 102), such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the system computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the system computing entity 106 may include, or be in communication with, one or more input elements, such as a keyboard input, a mouse input, a touch screen/display input, motion input, movement input, audio input, pointing device input, joystick input, keypad input, and/or the like. The system computing entity 106 may also include, or be in communication with, one or more output elements (not shown), such as audio output, video output, screen/display output, motion output, movement output, and/or the like.

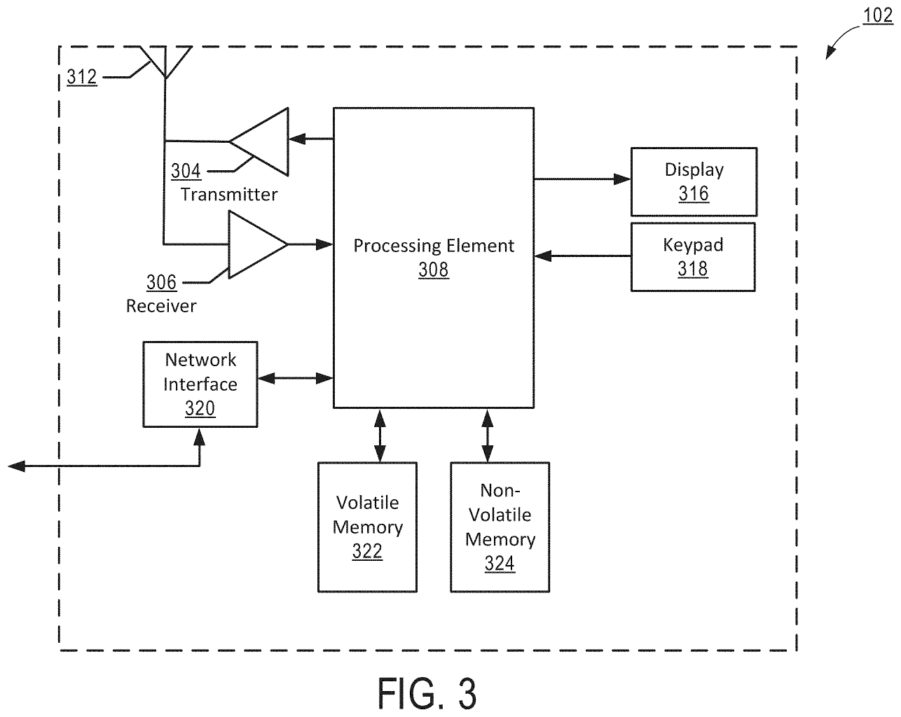

FIG. 3 provides a schematic of an example client computing entity 102 that may be used in conjunction with embodiments of the present disclosure. Client computing entities 102 can be operated by various parties, and the system architecture 100 may include one or more client computing entities 102.

As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the system computing entity 106. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the system computing entity 106 via a network interface 320.

Via these communication standards and protocols, the client computing entity 102 can communicate with various other entities (e.g., system computing entities 106, storage subsystem 108) using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like.

Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the system computing entity 106, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the system computing entity 106, various other computing entities, and/or a storage subsystem 108.

In another embodiment, the client computing entity 102 may include one or more components or functionality that are the same or similar to those of the system computing entity 106, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. Exemplary System Operations

In data objects having unstructured and semi-structured formats (e.g., free-flowing text), interpretable context and meaning for portions of data may not be explicitly defined, thus introducing technical challenges in automatic processing of such unstructured and semi-structured data objects. For example, while a human user (equipped with domain knowledge and contextual understanding) may readily recognize that a particular numerical data value appearing in an unstructured data object is meant to quantify a particular concept, entity, property, characteristic, and/or the like that may appear elsewhere within the unstructured data object, the unstructured data object may not include data that explicitly defines such a quantification relationship, or may not be structured to allow the relationship to be consistently and reliably derived. Accordingly, various embodiments of the present disclosure provide solutions that address various technical challenges and that enable consistent, reliable, and accurate interpretation of concept-specific or entity-specific data within unstructured and semi-structured data objects.

As described below, various embodiments of the present disclosure address technical challenges associated with improving applicability, consistency, and reliability of data record and document interpretation server systems. For example, various embodiments of the present disclosure enable a data record interpretation server system to extract portions of data from unstructured or semi-structured data records that are associated with a specific concept, entity, property, characteristic, and/or the like without the data records having such associations explicitly defined. Accordingly, by extraction of interpretable data (e.g., entity-specific data) from unstructured data records, various embodiments address technical challenges associated with applicability of data record interpretation server systems with unstructured or semi-structured data objects, generally. Further, various embodiments of the present disclosure provide classification models (e.g., comprising one or more machine learning models) that enable end-to-end automation of record retrieval and interpretation, thereby obviating manual inputs and actions to improve operational efficiency and throughput of record interpretation server systems, in various examples.

As further described below, various embodiments of the present invention make important technical contributions to improving data storage efficiency. For example, various embodiments of the present invention disclose techniques for generating structured data based at least in part on unstructured/semi-structured data by extracting key-value associations from the unstructured/semi-structured data. Because associated keys and values form only a subset of an unstructured/semi-structured corpus, storing structured data generated based at least in part on underlying unstructured/semi-structured data requires less storage resources than storing the underlying unstructured/semi-structured data. In this way, by disclosing techniques for generating structured data based at least in part on unstructured/semi-structured data, various embodiments of the present invention improve storage efficiency of storing data and reduce the amount of storage resources needed for storing data. In this way, various embodiments of the present invention make important technical contributions to improving data storage efficiency.

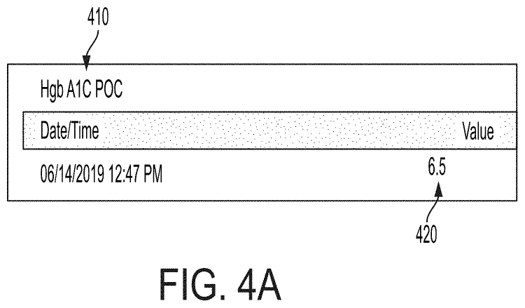

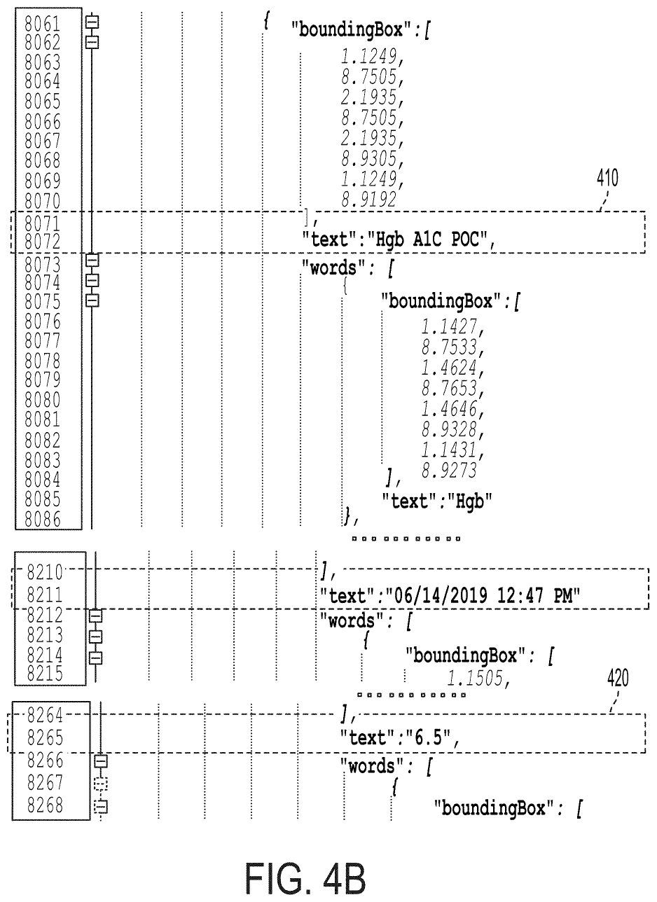

FIGS. 4A and 4B demonstrate example technical challenges addressed by various embodiments of the present disclosure. FIG. 4A illustrates an unstructured data record, and in the illustrated embodiment, the unstructured data record is an image scan of a medical chart. As such, while various data including a label data token 410 (e.g., Hgb A1C POC identifying an entity of a blood sugar amount) and a value data token 420 (e.g., 6.5 quantifying the entity of blood sugar amount) are captured within the unstructured data record, the unstructured data record may lack data or metadata associating the label data token 410 with the value data token 420. Other data describing other entities such as date/time are also captured within the unstructured data record. Without the data or metadata that describes associations between value data tokens 420 and label data tokens 410, the entity-specific domain, meaning, and context of the value data tokens 420 may be unclear to existing record interpretation systems, in various examples.

FIG. 4B illustrates another example format of the unstructured data record provided in FIG. 4A. Specifically, the format shown in FIG. 4B may be a processing output generated based at least in part on performing image text extraction (e.g., optical character recognition, or OCR) techniques and operations on the image scan in FIG. 4A. As shown, while textual data and other metadata (e.g., bounding box coordinates) for the label data tokens 410 and the value data tokens 420 can be extracted from an unstructured data record, associations and relationships between the label data tokens 410 and the value data tokens 420 are not derived through the OCR techniques, for example. Indeed, in the illustrated embodiment, the label data token 410 and the value data token 420 remain separated in different portions of this format of the unstructured data record and unrelated.

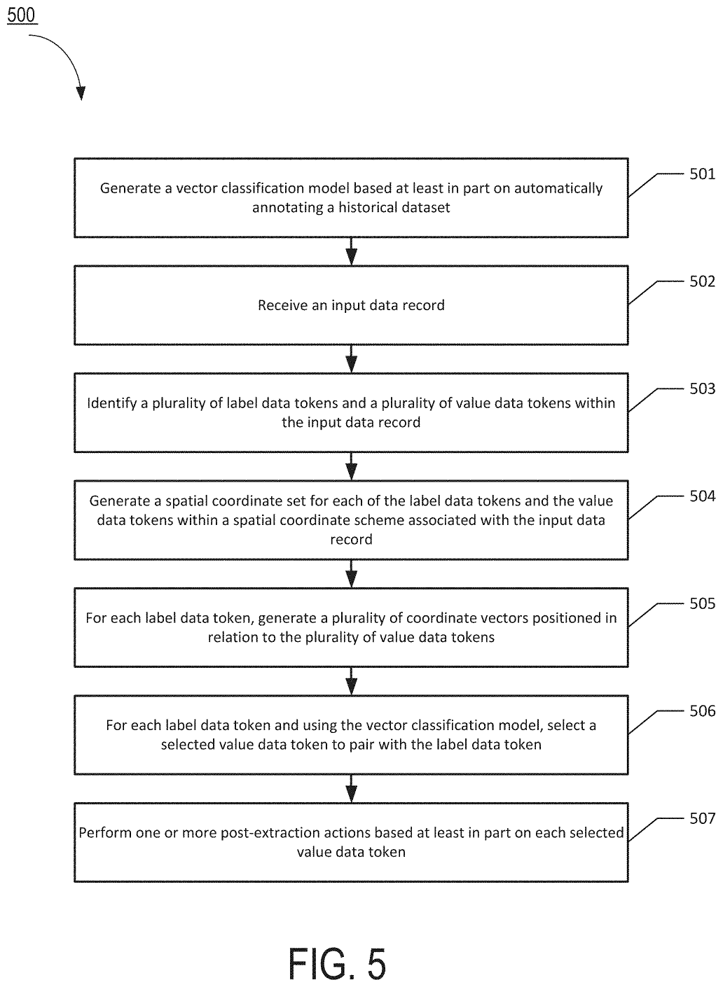

Various embodiments address at least these technical challenges by automatically identifying and extracting label-value pairs within unstructured data records, thereby rendering and extending interpretability to data captured in unstructured and semi-structured formats. In particular, various embodiments extract label-value pairs according to relative spatial positioning and orientation of label data tokens 410 and value data tokens 420 with respect to rendered formats of the unstructured data records (e.g., displayed, printed, and/or the like formats, such as the image scan format of FIG. 4A). Referring now to FIG. 5, a flowchart diagram is provided to illustrate an example process 500 for automatically extracting interpretable and entity-specific data from an unstructured data record, or specifically extracting label-value pairs. In various embodiments, the system computing entity 106 comprises means, such as the processing elements 205, memory media 210, 215, network interface 220, and/or the like, for performing steps/operations of process 500 to automatically extract label-value pairs from an unstructured data record.

Process 500 includes step/operation 501, at which a vector classification machine learning model is generated based at least in part on automatically annotating a historical dataset of data records. Generally, the vector classification machine learning model is configured to learn relative spatial positionings and orientations between label data tokens 410 and value data tokens 420 that are associated with the same entity (e.g., concept, property, characteristic, and/or the like). In particular, the vector classification machine learning model learns coordinate vectors (defining the relative spatial positionings and orientations) of “ground-truth” label-value pairs that are defined based at least in part on automatic annotation of historical data records, and the vector classification machine learning model may be configured to then classify a new coordinate vector with regard to whether the new coordinate vector is indicative of a potential label-value pair.

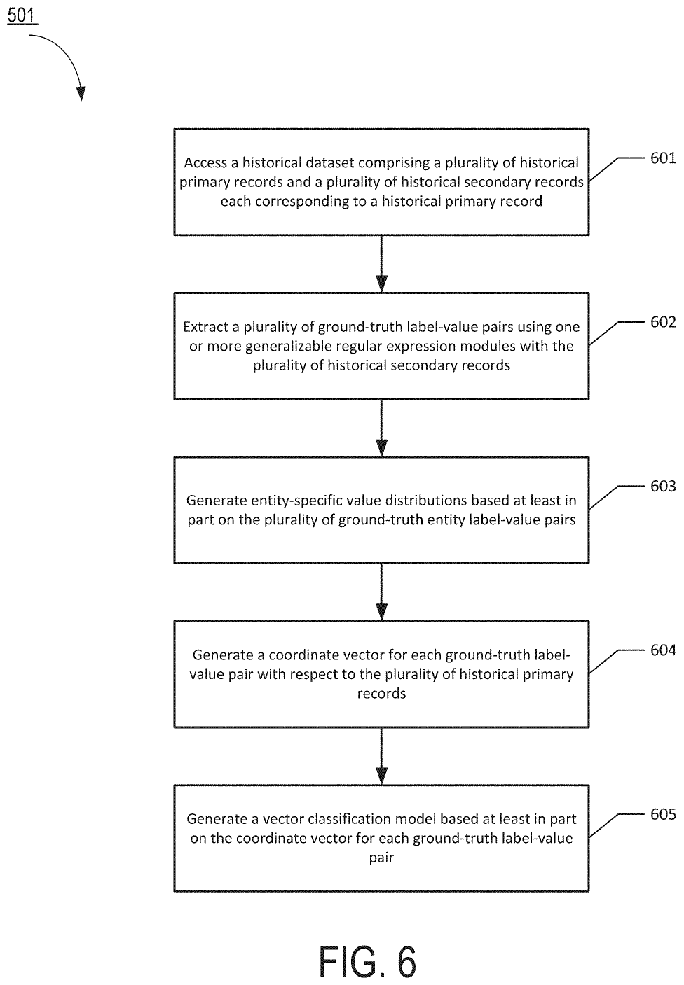

FIG. 6 provides a flowchart diagram of various example operations that provide an example embodiment of step/operation 501 for generating a vector classification machine learning model. At step/operation 601, a historical dataset comprising a plurality of historical primary data records and a plurality of historical secondary data records is accessed. In various embodiments, each historical secondary data record corresponds to a historical primary data record and serves as a semantic description of the data captured within the corresponding historical primary data record. For example, a historical secondary data record comprises free-flowing text, in some example embodiments. In an illustrative example, a historical primary data record may be embodied by a medical record or a medical chart, while a historical secondary data record corresponding to the historical primary data record may be embodied by doctor or nurse summary notes for the medical record/chart. Generally, in various embodiments, the historical primary data records are unstructured data records from which “ground-truth” coordinate vectors are learned by the vector classification machine learning model. Accordingly, the historical primary data records including label data tokens 410 and value data tokens 420 that may be associated with one or more entities, and the label data tokens 410 and the value data tokens 420 are also captured in the historical secondary data records.

While the label-value pairs may not be explicitly defined in data or metadata of the historical primary data records, the label-value pairs may be more apparent and detectable in their semantic textual form as provided by the corresponding historical secondary data records. For example, a historical secondary data record may include semantic textual data such as the height was 6 feet. Accordingly, at step/operation 602, a plurality of ground-truth label-value pairs are extracted from the plurality of historical secondary data records using one or more generalizable regular expression modules configured to parse semantic textual data, or one or more label-value pair regular expressions. In various embodiments, the one or more generalizable regular expression modules that may be generated and used at step/operation 602 are configured to identify portions of the historical secondary data records that comprise both a label data token and its corresponding value data token. Such portions may be sentences, phrases, text strings, and/or the like (e.g., the height was 6 feet), in which the value data token is approximately adjacent to, nearly immediately follows, or nearly immediately precedes the corresponding label data token. Thus, with the semantic form provided by the historical secondary data records, generalized regular expression modules may be used to identify a label data token 410 and a value data token 420 within the same text portion with the implication that the label data token 410 and the value data token 420 are associated with the same entity due to their semantic position and relationship.

Generally, in various embodiments, the one or more generalized regular expression modules are used to first identify label data tokens 410 and then to search for value data tokens 420 near the identified label data tokens. The one or more generalized regular expression modules include regular expressions that are configured to identify various different label data tokens 410 that may refer to the same entity such that entity-specific data can be comprehensively identified, in various examples. For instance, an example regular expression may be ‘\hat{ }[hH][eE]{0,1}[iI]{0,1}[gG]{0,1}[hH]{0,1}[tT].{0,10}\\d*\\.?\\d.{15}’, so defined to identify different label data tokens 410 that refer to a height entity. Specifically, a starting character and an ending character are specified and required, while intermediary characters may be present or not, so different label data tokens 410 such as Height, HT, Hgt, and HGHT are each identified by the example regular expression. In various embodiments, the one or more generalized regular expression modules include regular expressions configured for identifying single-word label data tokens and regular expressions configured for identifying multi-word label data tokens (e.g., body mass index).

As discussed, the generalized regular expression modules are configured to be used to identify value data tokens 420 appearing in the text portion of an identified label data token, such as preceding, following, or generally near the identified label data token. In the above example regular expression, the ‘\\d*\\.?\\d.{15}’ is configured to identify value data tokens 420 following the label data token 410 (as well as characters defining a measurement unit), for example. With the generalized regular expression modules, ground-truth label-value pairs can then be formed with the identified label data tokens and the identified value data tokens in the historical secondary data records.

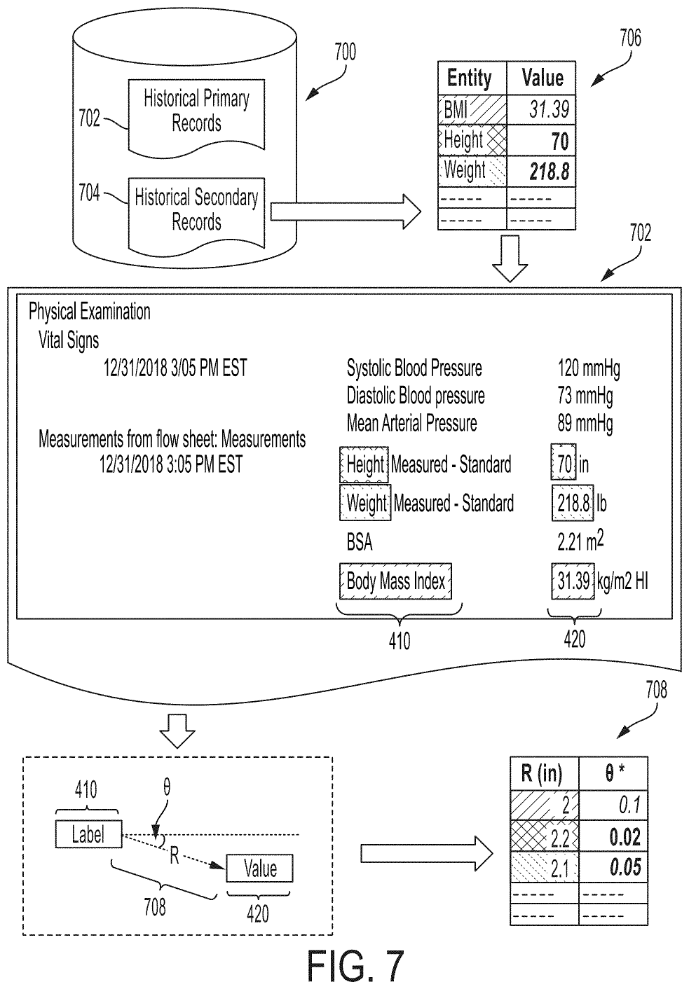

Referring briefly to FIG. 7, a diagram is provided that generally illustrates the generation of a vector classification machine learning model in accordance with the example operations illustrated in FIG. 6. As shown in FIG. 7, a historical dataset 700 includes historical primary data records 702 and historical secondary data records 704, and ground-truth label-value pairs 706 are generated using the historical secondary data records 704, specifically. For example, in the illustrated embodiment, the ground-truth label-value pairs 706 include a pairing between a label data token of BMI and a value data token of 31.39, another pairing between a label data token of Height and a value data token of 70, and another pairing between a label data token of Weight and a value data token of 218.8.

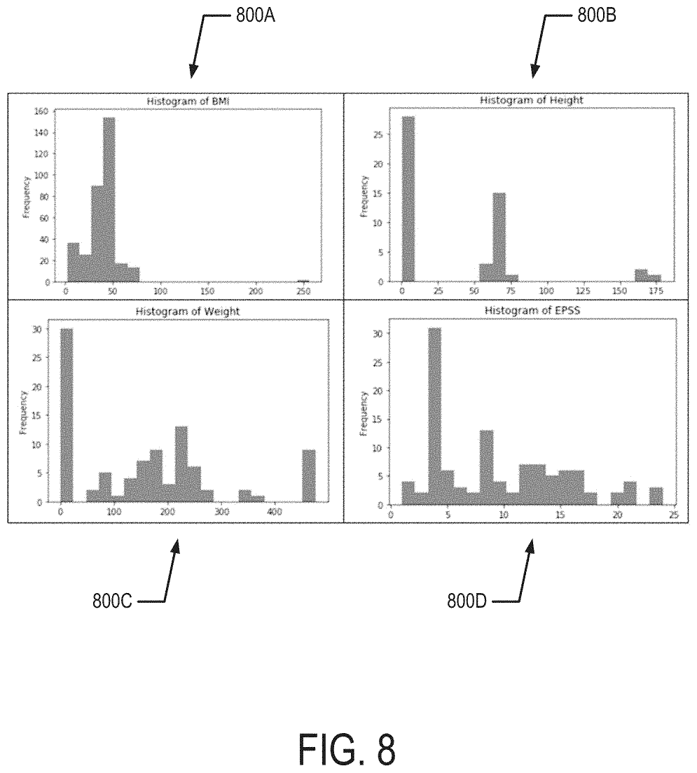

Returning to FIG. 6, at step/operation 603, entity-specific value distributions may be generated using the ground-truth label-value pairs. Generally, an entity-specific value distribution describes the value data tokens 420 that have been paired with label data tokens 410 for a given entity in the ground-truth label-value pairs 706. FIG. 8 provides four examples of entity-specific value distributions 800, each being shown in the form of a histogram providing a frequency of different value ranges or bins. In the illustrated embodiment, a first entity-specific value distribution 800A describes frequencies of value data tokens 420 in the ground-truth label-value pairs for a body mass index measure entity (e.g., identified by label data tokens 410 of BMI, body mass index, or body MI). A second entity-specific value distribution 800B describes value frequencies for a height entity, a third entity-specific value distribution 800C describes value frequencies for a weight entity, and a fourth entity-specific value distribution 800D describes value frequencies for a sleepiness score (EPSS) entity. It will be appreciated that various clusters and/or peaks that appear in an entity-specific value distribution may correlate with value data tokens 420 defined according to different measurement units.

According to various embodiments described herein, an entity-specific value distribution 800 may be used as a criteria for determining whether a given value data token is associated with a given entity. For example, a probability or likelihood that a given value data token is associated with a given entity may be based at least in part on whether the given value data token is an expected value for the given entity according to the entity-specific value distribution for the given entity.

At step/operation 604, label data tokens 410 and value data tokens 420 belonging to the ground-truth label-value pairs 706 are found within the historical primary data records 702 and a coordinate vector is generated for each ground-truth label-value pair with respect to spatial coordinate schemes associated with the historical primary data records (or their rendered forms). FIG. 7A illustrates an example rendered form of a historical primary data record 702 within which the ground-truth label-value pairs 706 are found.

With identification of each label data token 410 and each value data token 420 of the ground-truth label-value pairs 706 within the historical primary data records 702, coordinate vectors 708 that span between the label data tokens 410 and the value data tokens 420 can be defined and generated. For example, for the pairing of the label data token 410 of Height and the value data token 420 of 70, a coordinate vector is defined to span from spatial location of Height within the historical primary data record 702 to the spatial location of 70 within the historical primary data record 702 (or vice versa). In various embodiments including the illustrated embodiment of FIG. 7A, the coordinate vectors 708 may each be defined by a distance (e.g., R) and an angle (e.g., 0 with respect to a horizontal axis). In some example embodiments, the coordinate vectors 708 may be defined according to different models, such as via one or more regression or line coefficients, for example. In any regard, a coordinate vector 708 describes a relative spatial positioning and orientation of a label data token 410 and a value data token 420 of a ground-truth label-value pair 706. Therefore, the coordinate vectors 708 generated here “annotate” the historical primary data records and serve as ground-truth indications of label-value pairings within the historical primary data records as informed by corresponding historical secondary data records.

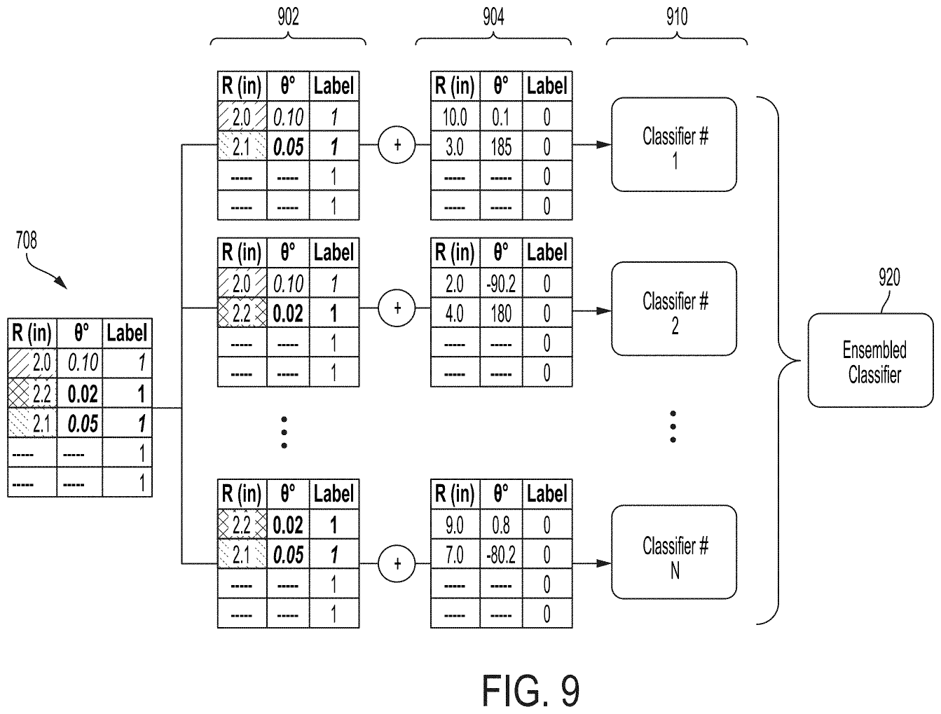

Then, at step/operation 605, the vector classification machine learning model may be generated based at least in part on the coordinate vector 708 for each ground-truth label-value pair 706. In various embodiments, the vector classification machine learning model may be a learned model; for example, the vector classification machine learning model comprises one or more classifier machine learning models trained using the ground-truth coordinate vectors. FIG. 9 illustrates one example training scheme and architecture of a vector classification machine learning model embodied by an ensembled classifier 920 that comprises N number of classifier machine learning models 910. In the illustrated embodiment, randomly selected subsets 902 of the ground-truth coordinate vectors are generated, with each randomly selected subset 902 being used for one of the N number of classifier machine learning models 910. In addition to the randomly selected subsets 902, negative sample subsets 904 may be generated for each of the N number of classifier machine learning models. In various embodiments, the negative sample subsets 904 include negative coordinate vectors having randomly-sampled distance aspects and randomly-sampled angle aspects, such that the coordinate vectors of the negative sample subsets 904 are likely not indicative of true label-value pairs. In some example embodiments, the negative coordinate vectors may be generated based at least in part on random sampling from a uniform distribution of distance aspects (e.g., bounded by dimensions of a rendered format of a data record, such as 8.5 inches and 11 inches) and a uniform distribution of angle aspects (e.g., distributed between 0 degrees and 360 degrees).

With the ground-truth coordinate vectors of the randomly selected subsets 902 and the negative coordinate vectors of the negative sample subsets 904, each classifier machine learning model 910 may be trained via supervised learning to discriminate and discern coordinate vectors that are indicative of label-value pairs. In various embodiments, each classifier machine learning model 910 comprises a deep neural network model having nodal parameters and biases that are configured using a loss measure and backpropagation, for example. In various embodiments, each classifier machine learning model 910 is configured to output a pairing score (e.g., between 0 and 1) describing a predicted likelihood that a given coordinate vector is indicative of a label-value pair.

Following training of the N number of classifier machine learning models 910, an ensembled classifier 920 may be generated to embody the vector classification machine learning model, with the ensembled classifier 920 using a voting mechanism for the N number of classifier machine learning models 910. For example, in the ensembled classifier 920, each classifier machine learning model 910 is configured to receive an input coordinate vector and generate a respective pairing score and/or classification for the input coordinate vector, whereupon the ensembled classifier 920 is configured to provide an aggregated output based at least in part on a majority vote between the pairing score and/or classification outputs across the N number of classifier machine learning models 910, an averaging of pairing scores, and/or the like. For example, the ensembled classifier 920 may be a random forest-based classifier model.

While FIG. 9 shows but one example training scheme and model configuration for the vector classification machine learning model, it will be understood that different training schemes and model configurations may be implemented, depending on the embodiment. For example, one classifier machine learning model 910 may be used to embody the vector classification machine learning model, rather than an ensembled classifier 920 comprising multiple classifier machine learning models 910, in order to conserve upon operational resource costs, training resource costs, dedicated storage space, and/or the like. As another example, the classifier machine learning model(s) 910 may be trained with additional features beyond the distance aspect and the angle aspect of the coordinate vectors 708, such as with z-score of the distance aspect, z-score of the angle aspect, frequency, and/or the like. As yet another example, value data tokens 420 may be intentionally matched incorrectly to different label data tokens 410 to generate the negative coordinate vectors for training, as opposed to the random sampling of uniform distributions, for example.

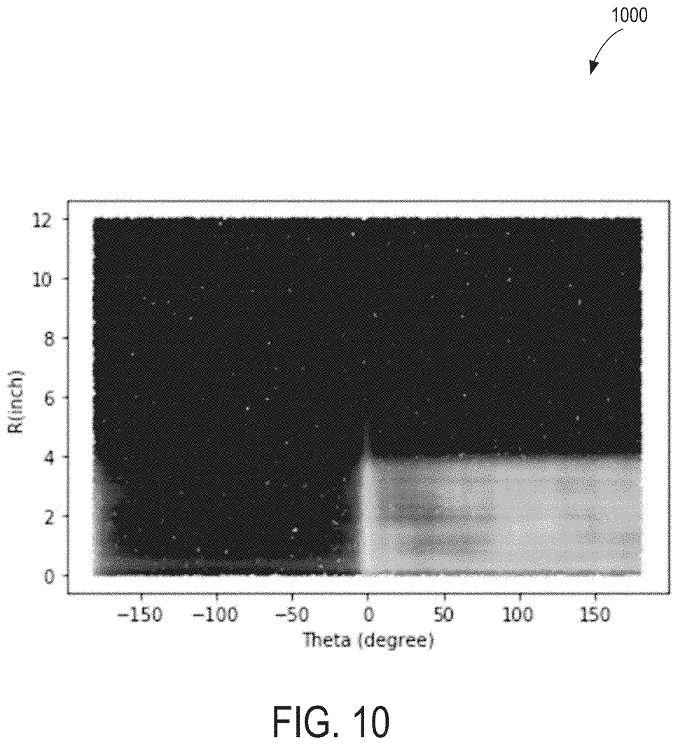

In various embodiments, the vector classification machine learning model may be a probabilistic model; for example, the vector classification machine learning model includes a probability/frequency distribution for the distance aspect (e.g., R) of the ground-truth coordinate vectors, a probability/frequency distribution for the angle aspect (e.g., θ) of the ground-truth coordinate vectors, a joint probability distribution with respect to both the distance aspect and the angle aspect of the ground-truth coordinate vectors, and/or the like. FIG. 10 illustrates an example joint probability distribution 1000 with respect to the distance aspect and the angle aspect of the ground-truth coordinate vectors. Accordingly, a vector classification machine learning model embodied by a joint probability distribution 1000 provides knowledge of ground-truth coordinate vectors against which an input coordinate vector can be compared and classified. For instance, using the vector classification machine learning model, an input coordinate vector having an angle aspect falling outside of configurable threshold ranges of the angle aspect probability distributions may be classified as not being indicative of a label-value pair. Such configurable threshold ranges may be defined according to high-density areas of the joint probability distribution 1000, for example. Thus, the joint probability distribution 1000 may be accompanied with configurable thresholds and/or rules to embody the vector classification machine learning model. In the illustrated embodiment of FIG. 10, high-density areas define coordinate vectors having distance aspects of less than four inches and angle aspects of approximately zero degrees (e.g., label-value pairs in which the value data token 420 is approximately horizontally aligned with the label data token 410, for example) as well as angle aspects of approximately 90 to 120 degrees (e.g., label-value pairs in which the value data token 420 is positioned approximately below the label data token 410, for example).

Accordingly, as described herein, a vector classification machine learning model is generated based at least in part on exploiting semantic formats of historical secondary data records that correspond to historical primary data records having unstructured or semi-structured formats in order to annotate ground-truth coordinate vectors within the historical primary data records. With the ground-truth coordinate vectors, training data is automatically generated such that a vector classification machine learning model can learn features of coordinate vectors that are indicative of label-value pairs and use the learned knowledge to classify an input coordinate vector as being indicative of a label-value pair or not (e.g., whether the input coordinate vector spans between a label data token 410 and a value data token 420 associated with the same entity). With the historical secondary data records being automatically parsed via generalized regular expression modules, manual inputs and operations typically needed for annotation and generation of testing data is obviated, leading to end-to-end automation benefits provided by various embodiments described herein.

Returning to FIG. 5, the generated vector classification machine learning model may then be applied and used in a pipeline of example operations to provide technical improvements in data document and record interpretation server systems by automatically extracting label-value pairs from unstructured data records, for example. While in some example embodiments, the system computing entity 106 is configured to perform various example operations (e.g., as illustrated in FIG. 6) to generate the vector classification machine learning model, other various example embodiments may include the system computing entity 106 receiving a pre-trained vector classification machine learning model from another computing entity, from an online server system, and/or the like.

Process 500 includes step/operation 502, at which an input data record is received, and the input data record may be in an unstructured or a semi-structured format. For example, the input data record may be an image scan of medical record or a medical chart in which label data tokens 410 and value data tokens 420 are rendered in a tabular arrangement, without the tabular arrangement being defined in the data or metadata of the image scan. In various embodiments, the input data record may originate from another system such as an image scan system, an auto-generation system, and/or the like or from external computing entities, such as client computing entities 102.

Process 500 includes step/operation 503, at which entity data tokens are identified within the input data record. Specifically, the identified entity data tokens include a plurality of label data tokens and a plurality of value data tokens. To enable identification of the entity data tokens, image text extraction (e.g., OCR) techniques may be performed to generate textual data for content captured within the input data record. In various embodiments, the label data tokens are identified based at least in part on a pre-defined list of entities. For example, a list of entities may be pre-defined according to one or more schemes, one or more rules, one or more policies, and/or the like and generally include entities for which data is of interest. Based at least in part on how the entities are specified within the pre-defined list of entities, label variants can be derived. For example, if the pre-defined list of entities includes Height, label data tokens 410 that may vary from Height such as Ht. or HGHT may be identified within the input data record. In various embodiments, the label data tokens 410 are identified based at least in part on searching a text-based output from the image text extraction (e.g., OCR techniques), such as the text-based format shown in FIG. 4B.

In various embodiments, value data tokens 420 may be identified based at least in part on searching for numeric values, text characters representing numerals, text characters forming known categorical variables (e.g., yes, no, true, blue, New York), and/or the like within the text-based output from the image text extraction. In various embodiments, the value data tokens 420 may be identified and filtered according to entity-specific value distributions 800. In particular, given a pre-defined list of entities, an entity-specific value distribution 800 for each entity may be retrieved, and value data tokens 420 that fall within configurable ranges as defined in accordance with the entity-specific value distribution 800 may be identified. For instance, percentage-based confidence intervals may be used to search for and identify value data tokens 420 present within the input data record.

Process 500 includes step/operation 504, at which a spatial coordinate set is generated for each entity data token, or specifically for each label data token 410 and each value data token 420. In various embodiments, OCR techniques performed on an image scan embodying the input data record output a bounding box defined by a spatial coordinate set for each data token, with the spatial coordinate set describing spatial location and bounds of the data token. In various embodiments, the spatial coordinate set comprises coordinate points for box corners, a box center, and/or the like. In various embodiments, the spatial coordinate set is generated with respect to a spatial coordinate scheme for the input data record, such as dimensions and bounds associated with a rendered format (e.g., a printed format with dimensions 8.5″ by 11″). In various embodiments, the spatial coordinate scheme may be defined (and augmented) with multiple pages of the input data record being concatenated. Generally, with concatenation of pages or other similar processing, each spatial location of the input data record is uniquely defined.

Process 500 includes step/operation 505, at which a plurality of coordinate vectors are generated for each label data token 410. Specifically, each coordinate vector is positioned in relation to (e.g., spans or extends to) one of the plurality of value data tokens 420. In various embodiments, each coordinate vector comprises a distance aspect and an angle aspect. For instance, the distance aspect may generally be a multi-dimensional distance or norm between two spatial coordinate sets (one for the label data token 410 and one for a value data token 420), and may be determined (in a two-dimensional space) as: R=\sqrt{(X^{label}−X^{value})²+(Y^{label}−Y^{value})²}, for example. Meanwhile, the angle aspect may generally describe an axis deviation or axis-based orientation between two spatial coordinate sets, and may be determined (in a two-dimensional space) as:

$$θ = {tan}^{- 1} \frac{{Y}^{value} - {Y}^{entity}}{{X}^{value} - {X}^{entity}} ,$$

for example. With the plurality of coordinate vectors for a label data token 410, multiple value data tokens 420 can be evaluated for pairing with the label data token 410.

Process 500 includes step/operation 506, at which a value data token may be selected for pairing with each label data token 410 using the vector classification machine learning model and the plurality of coordinate vectors for each label data token 410. That is, the value data token corresponding to a coordinate vector that is best or most indicative of a label-value pair out of the plurality of coordinate vectors is selected for pairing with the label data token 410, in various embodiments. In some examples, no value data token may be paired to a label data token 410 if each coordinate vector is determined to not be significantly indicative of a label-value pair; thus, the label data token 410 may be unpaired in some instances. In various embodiments, the value data token 420 is selected based at least in part on a classification and/or pairing score output by the vector classification machine learning model, with the classification and/or pairing score indicating a predicted likelihood that a given coordinate vector is indicative of a label-value pair.

While various embodiments are described herein with a label-centric perspective in which a value data token 420 selected from a plurality of value data tokens 420 is paired to a label data token 410, it will be appreciated that alternative embodiments may include a value-centric perspective. For example, a label data token 410 is selected from a plurality of label data tokens 410 to be paired with a value data token 420 according to evaluation of a plurality of coordinate vectors positioned with respect to the plurality of label data tokens 410.

Process 500 includes step/operation 507, at which one or more post-extraction actions are performed based at least in part on the label-value pairs, or the selected value data token for each of the label data tokens 410. In various embodiments, the post-extraction actions include record classification actions, such as providing the label-value pairs to a record classification machine learning model configured to generate a classification for the input data record. In particular, the value data tokens 420 paired to each label data token 410 are used as categorical input features provided to the record classification machine learning model. In some examples, the classification for the input data record may control how the input data record may be further processed by post-extraction systems.

Similarly, the post-extraction actions may include entity classification actions, such as classifying an overarching entity based at least in part on the label-value pairs that describe entities belonging to the overarching entity. For instance, the input data record is a medical record or chart, and the label-value pairs that are extracted relate to physiological measurement entities. With extraction of data with regard to which value data tokens 420 describe (e.g., quantify) which physiological measurements, the label-value pairs may be provided to a diagnosis model, which may be a rule-based model, a machine learning model, and/or the like that generates a diagnosis, risk measurement, or classification for a patient entity.

Further yet, the post-extraction actions may include value generation actions, in which potentially missing or undetected value data tokens may be generated using other value data tokens 420 and their pairings. As discussed, a label data token 410 may remain unpaired if no coordinate vectors are significantly indicative of a label-value pair, and other label-value pairs may be used to generate a supplemental value data token for the label data token 410. In various embodiments, one or more generative machine learning models (e.g., a generative adversarial network, an autoencoder model, an encoder-decoder model, and/or the like) may be used to generate a supplemental value data token for an unpaired label data token using one or more extracted label-value pairs.

In various embodiments, the post-extraction actions may include summarization actions that generate a summary data object corresponding to and generally describing the input data record. In various embodiments, the summary data object comprises the label-value pairs, and may capture in a label-value pairs in a structured format for example. In various embodiments, the summary data object may include semantic data, similar to the historical secondary data records 704, and serve as a corresponding description of the input data record, also similar to the historical secondary data records 704. Thus, in some example embodiments, the summarization actions include automatically generating a secondary data record for the input data record.

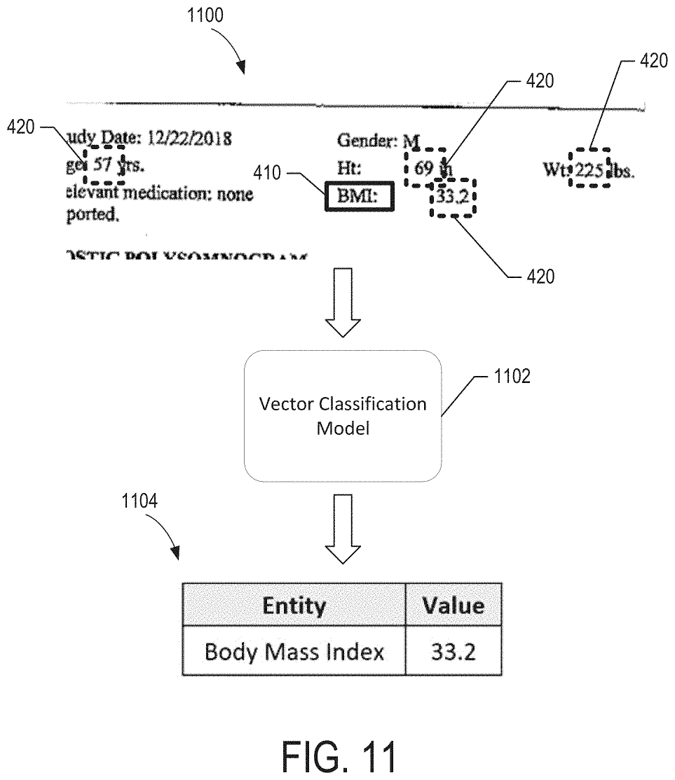

FIG. 11 provides a diagram illustrating automatic extraction of interpretable entity-specific data, specifically a label-value pair, from an input data record 1100 in accordance with various example operations described above. In FIG. 11, an input data record 1100 having an unstructured format is shown; the input data record 1100 is an image scan that lacks data or metadata that explicitly links value data tokens 420 with label data tokens 410 or that defines the entity described by each value data token 420. As shown, a plurality of value data tokens 420 (e.g., 57, 69, 33.2, and 225) may be identified as pairing candidates for a label data token 410 of BMI.

In various embodiments, a plurality of coordinate vectors are generated and positioned in relation to the plurality of value data token 420. For example, a first coordinate vector may be generated and span between respective spatial coordinate sets for the label data token 410 of BMI and a first value data token of 57, a second coordinate vector for BMI and 69, a third coordinate vector for BMI and 33.2, and a fourth coordinate vector for BMI and 225. The coordinate vectors are then provided to a vector classification machine learning model 1102 (e.g., embodied by an ensembled classifier 920, a joint probability distribution 1000, and/or the like) configured to output a classification and/or a pairing score for each coordinate vector that represents a predicted likelihood that a coordinate vector is indicative of a label-value pair—or a predicted likelihood that the value data token 420 to which a coordinate vector extends likely describes (e.g., quantifies) the entity identified by the label data token 410 of BMI. Based at least in part on the outputs of the vector classification machine learning model 1102 with respect to the different coordinate vectors, a value data token 420 may be selected to be paired with the label data token 410 of BMI, in the illustrated example. For instance, the vector classification machine learning model 1102 determines that the value data token 420 of 33.2 is most likely to be paired with the label data token 410 of BMI based at least in part on the coordinate vector spanning between BMI and 33.2. Thus, a label-value pair 1104 is generated, and the value data token 420 of 33.2 may be associated with metadata that indicates that it is relevant to the BMI entity.

In some embodiments, performing the post-extraction actions include performing operational load balancing for the post-prediction systems that perform operations on structured data that are generated based at least in part on extracted key-value associations extracted from unstructured/semi-structured data objects. For example, in some embodiments, a predictive data analysis computing entity determines D structured data objects for S unstructured/semi-structured data objects. Then, the count of D structured data objects, along with a resource utilization ratio for each structured data object, can be used to predict a predicted number of computing entities needed to perform post-prediction processing operations with respect to the D structured data objects. For example, in some embodiments, the number of computing entities needed to perform post-prediction processing operations (e.g., structured data processing operations) with respect to D structured data objects can be determined based at least in part on the output of the equation: R=ceil(Σₖ^{k=0} urₖ), where R is the predicted number of computing entities needed to perform post-prediction processing operations with respect to the D structured data objects, cell(.) is a ceiling function that returns the closest integer that is greater than or equal to the value provided as the input parameter of the ceiling function, k is an index variable that iterates over the D structured data objects, and urₖ is the estimated resource utilization ratio for a kth structured data objects that may be determined based at least in part on size of the structured data object. In some embodiments, once R is generated, a predictive data analysis computing entity can use R to perform operational load balancing for a server system that is configured to perform post-prediction processing operations with respect to D structured data objects. This may be done by allocating computing entities to the post-prediction processing operations if the number of currently-allocated computing entities is below R, and deallocating currently-allocated computing entities if the number of currently-allocated computing entities is above R.

Therefore, as described above, various embodiments of the present disclosure address technical challenges associated with improving applicability, consistency, and reliability of data record and document interpretation server systems. For example, various embodiments of the present disclosure enable a data record interpretation server system to extract portions of data from unstructured or semi-structured data records that are associated with a specific concept, entity, property, characteristic, and/or the like without the data records having such associations explicitly defined. Accordingly, by extraction of interpretable data (e.g., entity-specific data) from unstructured data records, various embodiments address technical challenges associated with applicability of data record interpretation server systems with unstructured or semi-structured data objects, generally. Further, various embodiments of the present disclosure provide classification models (e.g., comprising one or more machine learning models) that enable end-to-end automation of record retrieval and interpretation, thereby obviating manual inputs and actions to improve operational efficiency and throughput of record interpretation server systems, in various examples.

Moreover, as further described below, various embodiments of the present invention make important technical contributions to improving data storage efficiency. For example, various embodiments of the present invention disclose techniques for generating structured data based at least in part on unstructured/semi-structured data by extracting key-value associations from the unstructured/semi-structured data. Because associated keys and values form only a subset of an unstructured/semi-structured corpus, storing structured data generated based at least in part on underlying unstructured/semi-structured data requires less storage resources than storing the underlying unstructured/semi-structured data. In this way, by disclosing techniques for generating structured data based at least in part on unstructured/semi-structured data, various embodiments of the present invention improve storage efficiency of storing data and reduce the amount of storage resources needed for storing data. In this way, various embodiments of the present invention make important technical contributions to improving data storage efficiency.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer-implemented method comprising:
identifying, using at least one processor, a group of entity data tokens comprising a plurality of label data tokens and a plurality of value data tokens within an input data record;
for each entity data token, generating, using the at least one processor, a spatial coordinate set within a spatial coordinate scheme associated with the input data record;
for each label data token of the group of entity data tokens:
generating, using the at least one processor, a plurality of coordinate vectors positioned in relation to the plurality of value data tokens based at least in part on the spatial coordinate set for each of the plurality of value data tokens, and
selecting, using the at least one processor and a vector classification machine learning model, a selected value data token for the label data token based at least in part on the plurality of coordinate vectors, wherein the vector classification machine learning model is generated based at least in part on automatic annotation of a historical dataset of data records using one or more label-value pair regular expressions; and
performing, using the at least one processor, one or more post-extraction actions based at least in part on each selected value data token.

2. The computer-implemented method of claim 1, wherein at least the plurality of label data tokens are identified using a label-detecting regular expression for each label data token to parse the input data record.

3. The computer-implemented method of claim 1, wherein the vector classification machine learning model is generated further based at least in part on:
accessing the historical dataset, wherein the historical dataset comprises a plurality of historical primary data records and a plurality of historical secondary data records each corresponding to one of the plurality of historical primary data records;
extracting a plurality of ground-truth label-value pairs from the plurality of historical secondary data records;
generating a plurality of ground-truth coordinate vectors based at least in part on identifying the plurality of ground-truth label-value pairs in the plurality of historical primary data records;
training the vector classification machine learning model using the plurality of ground-truth coordinate vectors.

4. The computer-implemented method of claim 3, wherein each historical secondary data record semantically describes data in the corresponding historical primary data record, and wherein the plurality of ground-truth label-value pairs are extracted using the one or more label-value pair regular expressions to parse each historical secondary data record.

5. The computer-implemented method of claim 1, wherein the vector classification machine learning model comprises one or more classifier machine learning models configured to predict whether an input coordinate vector is indicative of a label-value pair.

6. The computer-implemented method of claim 1, wherein the spatial coordinate set for each entity data token is generated in accordance with bounding boxes generated for each label data token and each value data token via optical character recognition techniques.

7. The computer-implemented method of claim 1, wherein the plurality of coordinate vectors each comprise an angle and a distance and each configured to describe a relative positioning of the label data object and a value data object in a rendered format.

8. The computer-implemented method of claim 7, wherein the vector classification machine learning model comprises a joint probability distribution with respect to at least the angle and the distance of a plurality of ground-truth coordinate vectors generated from the automatic annotation.

9. The computer-implemented method of claim 1, wherein the selected value data token is selected based at least in part on a pairing score assigned to each value data token based at least in part on an output of the vector classification machine learning model.

10. The computer-implemented method of claim 9, wherein the pairing score assigned to each value data token is further based at least in part on an entity-specific value distribution associated with the label data token.

11. The computer-implemented method of claim 1, wherein the one or more post-extraction actions comprises using each selected value data token to generate a record classification for the input data record.

12. The computer-implemented method of claim 1, wherein the one or more post-extraction actions comprises providing each selected value data token to a disease diagnosis model.

13. The computer-implemented method of claim 1, wherein the one or more post-extraction actions comprises generating a summarization data object for the input data record that comprises each selected value data token for at least a subset of the plurality of data tokens.

14. An apparatus comprising a processor and at least one memory comprising computer program code, the at least one memory and the computer program code configured to, with the processor, cause the apparatus to:
identify a group of entity data tokens comprising a plurality of label data tokens and a plurality of value data tokens within an input data record;
for each entity data token, generate a spatial coordinate set within a spatial coordinate scheme associated with the input data record;
for each label data token of the group of entity data tokens:
generate a plurality of coordinate vectors positioned in relation to the plurality of value data tokens based at least in part on the spatial coordinate set for each of the plurality of value data tokens, and
select, using a vector classification machine learning model, a selected value data token for the label data token based at least in part on the plurality of coordinate vectors, wherein the vector classification machine learning model is generated based at least in part on automatic annotation of a historical dataset of data records using one or more label-value pair regular expressions; and
perform one or more post-extraction actions based at least in part on each selected value data token.

15. The apparatus of claim 14, wherein the vector classification machine learning model is generated further based at least in part on:
accessing the historical dataset, wherein the historical dataset comprises a plurality of historical primary data records and a plurality of historical secondary data records each corresponding to one of the plurality of historical primary data records;
extracting a plurality of ground-truth label-value pairs from the plurality of historical secondary data records;
generating a plurality of ground-truth coordinate vectors based at least in part on identifying the plurality of ground-truth label-value pairs in the plurality of historical primary data records;
training the vector classification machine learning model using the plurality of ground-truth coordinate vectors.

16. The apparatus of claim 15, wherein each historical secondary data record semantically describes data in the corresponding historical primary data record, and wherein the plurality of ground-truth label-value pairs are extracted using the one or more label-value pair regular expressions to parse each historical secondary data record.

17. The apparatus of claim 14, wherein the vector classification machine learning model comprises one or more classifier machine learning models configured to predict whether an input coordinate vector is indicative of a label-value pair.

18. The apparatus of claim 14, wherein the plurality of coordinate vectors each comprise an angle and a distance and each configured to describe a relative positioning of the label data object and a value data object in a rendered format.

19. The apparatus of claim 18, wherein the vector classification machine learning model comprises a joint probability distribution with respect to at least the angle and the distance of a plurality of ground-truth coordinate vectors generated from the automatic annotation.

20. A computer program product comprising at least one computer-readable storage medium having computer-readable program code portions stored therein, the computer-readable program code portions including executable portions configured to cause at least one processor to:
identify a group of entity data tokens comprising a plurality of label data tokens and a plurality of value data tokens within an input data record;
for each entity data token, generate a spatial coordinate set within a spatial coordinate scheme associated with the input data record;
for each label data token of the group of entity data tokens:
generate a plurality of coordinate vectors positioned in relation to the plurality of value data tokens based at least in part on the spatial coordinate set for each of the plurality of value data tokens, and
select, using a vector classification machine learning model, a selected value data token for the label data token based at least in part on the plurality of coordinate vectors, wherein the vector classification machine learning model is generated based at least in part on automatic annotation of a historical dataset of data records using one or more label-value pair regular expressions; and
perform one or more post-extraction actions based at least in part on each selected value data token.
